(19) United States
(12) Patent Application Publication
(10) Pub. No.: US 2012/0044951 A1
(43) Pub. Date: Feb. 23, 2012

(54) ALIGNMENT APPARATUS AND METHOD

(75) Inventor: Kyeong Eun Han, Daejeon (KR)

(73) Assignee: Electronics and Telecommunications Research Institute, Daejeon (KR)

(21) Appl. No.: 12/960,911

(22) Filed: Dec. 6, 2010

(30) Foreign Application Priority Data
Aug. 18, 2010 (KR) 10-2010-0079891

(51) Int. Cl. H04L 12/56

(52) U.S. Cl. 370/419

(57) ABSTRACT

An alignment apparatus for dynamically operating lanes in a high speed Ethernet device having multiple lanes, includes: a PCS (Physical Coding Sublayer) upper layer managing lane information regarding all of the lanes and operational lanes; a PCS transmission unit receiving the lane information from the PCS upper layer and inserting an alignment marker into the operational lanes; a PMA (Physical Medium Attachment) layer receiving the alignment marker from the PCS transmission unit and transmitting the same, and receiving alignment marker from another alignment apparatus; and a PCS reception unit receiving the lane information from the PCS upper layer, receiving the alignment marker from the PMA layer, and performing alignment on the operational lanes.

### CROSS-REFERENCE TO RELATED APPLICATIONS

This application claims the priority of Korean Patent Application No. 10-2010-0079891 filed on Aug. 18, 2010, in the Korean Intellectual Property Office, the disclosure of which is incorporated herein by reference.

### BACKGROUND OF THE INVENTION

1. Field of the Invention

The present invention relates to an alignment apparatus and a method therefor and, more particularly, to an alignment apparatus and method for dynamically operating lanes in a high speed Ethernet device having multiple lanes.

2. Description of the Related Art

Recently, the IEEE 802.3ba task force is proceeding with a 40 Gbps and 100 Gbps Ethernet communications standard for a super-speed broadband transmission system, and it has adopted a multi-lane structure constituting a single high speed transmission link by using multiple lanes, each having a low transfer rate.

Thus, the interior of a PCS (physical coding sublayer) of a 100 giga bit Ethernet device and a 40 giga bit Ethernet device include twenty virtual lanes and four virtual lines, respectively, and ten electrical lanes and four electrical lanes are configured between the PCS layer and a PMA (physical medium attachment) layer, respectively.

The virtual lanes in the interior of the PCS layer aim to support a smooth combination of electrical lanes and optical lanes, for which a block distribution and combination are performed. Also, the electrical lanes correspond to a plurality of optical lanes through the PMA layer to transfer data.

The foregoing large capacity data transmission Ethernet system can dynamically use bandwidth for a particular purpose (e.g., controlling an error, reducing power consumption, or managing an array element, and the like) or according to a network situation, and to this end, lanes can be dynamically operated by using the large capacity Ethernet structure having multiple lanes.

However, when the lanes are dynamically used in the large capacity Ethernet based on multiple lanes, a transmission side and a reception side must know about the number of lanes and relevant information that change therebetween to ensure smooth communication, which, thus, requires an effective operating and processing method of a communication system or device.

In particular, because the PCS reception side performs an operation after receiving a synchronous bit or an alignment marker in every lane, it is sensitive to the information regarding the dynamically changing lanes, and the PCS transmission side must determine the number of alignment markers and a BIP (Bit Interleaved Parity) value according to the changing lane information. Thus, a proper alignment method in dynamically operating lanes is required.

### SUMMARY OF THE INVENTION

An aspect of the present invention provides an alignment apparatus for dynamically operating lanes in a high speed Ethernet device having multiple lanes.

Another aspect of the present invention provides an alignment method for dynamically operating lanes in a high speed Ethernet device having multiple lanes.

According to an aspect of the present invention, there is provided an alignment apparatus for dynamically operating lanes in a high speed Ethernet device having multiple lanes, including: a PCS (Physical Coding Sublayer) transmission unit receiving lane information regarding all lanes and operational lanes from a PCS upper layer and inserting an alignment marker into the operational lanes.

The alignment apparatus may further include: a PCS upper layer managing the lane information regarding all of the lanes and the operational lanes and providing the lane information to the PCS transmission unit; and a PMA (Physical Medium Attachment) layer receiving data the alignment marker from the PCS transmission unit and transmitting the same.

The lane information of the PCS upper layer may be dynamically changed.

The PCS upper layer may provide the lane information to another lane alignment device opposed thereto.

The PCS transmission unit may insert the alignment marker at every alignment marker insertion period into each of the operational lanes by using the received lane information.

The PCS transmission unit may use an alignment marker insertion period counter for inserting the alignment marker.

The PCS transmission unit may change the number of the operational lanes by using the received lane information.

According to another aspect of the present invention, there is provided an alignment apparatus for dynamically operating lanes in a high speed Ethernet device having multiple lanes, including: a PCS (Physical Coding Sublayer) reception unit receiving lane information regarding all of the lanes and operational lanes from a PCS upper layer, receiving alignment marker from a PMA (physical medium attachment) layer, and performing alignment on the operational lanes.

The alignment apparatus may further include: a PCS upper layer managing the lane information regarding all of the lanes and the operational lanes and providing the land information to the PCS reception unit; and a PMA layer receiving the alignment marker and providing the same to the PCS reception unit.

The PCS reception unit may perform alignment on the operational lanes by using an alignment marker counter.

The PCS reception unit may change the number of the operational lanes by using the received lane information.

The PCS upper layer may receive the lane information from another lane alignment apparatus opposed thereto.

According to another aspect of the present invention, there is provided an alignment apparatus for dynamically operating lanes in a high speed Ethernet device having multiple lanes, including: a PCS (Physical Coding Sublayer) upper layer managing lane information regarding all of the lanes and operational lanes; a PCS transmission unit receiving the lane information from the PCS upper layer and inserting an alignment marker into the operational lanes; a PMA (Physical Medium Attachment) layer receiving the alignment marker from the PCS transmission unit and transmitting the same, and receiving alignment marker from another alignment apparatus; and a PCS reception unit receiving the lane information from the PCS upper layer, receiving the alignment marker from the PMA layer, and performing alignment on the operational lanes.

According to another aspect of the present invention, there is provided an alignment method for dynamically operating lanes in a high speed Ethernet device having multiple lanes, including: changing the number of operational lanes according to lane information regarding all of the lanes and the operational lanes; inserting an alignment marker into each of the operational lanes according to a predetermined alignment marker insertion period; and transmitting the alignment marker.

The lane information may be dynamically changed.

An alignment marker insertion period counter may be used for the predetermined alignment marker insertion period.

After the alignment marker is inserted, the alignment marker insertion period counter may be reset.

According to another aspect of the present invention, there is provided an alignment method for dynamically operating lanes in a high speed Ethernet device having multiple lanes, including: receiving lane information regarding all of the lanes and operational lanes; receiving alignment marker; and performing alignment by using the lane information and the received alignment marker.

In the performing of alignment, alignment may be completed when the number of the received alignment markers and the number of the operational lanes according to the lane information are identical.

In the performing of alignment, when the number of the received alignment markers and the number of the operational lanes according to the lane information are not identical, the alignment may be processed as an error.

In the performing of alignment, alignment may be performed by using an alignment marker counter.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic block diagram of an alignment apparatus according to an exemplary embodiment of the present invention;

FIG. 2 is a schematic block diagram of an alignment apparatus according to another exemplary embodiment of the present invention;

FIG. 3 is a schematic block diagram of a PCS transmission unit of the alignment apparatus according to another exemplary embodiment of the present invention;

FIG. 4 is a schematic block diagram of an alignment apparatus according to another exemplary embodiment of the present invention;

FIG. 5 is a schematic block diagram of a PCS reception unit of the alignment apparatus according to another exemplary embodiment of the present invention;

FIG. 6 is a flow chart illustrating the process of an alignment method according to an exemplary embodiment of the present invention; and

FIG. 7 is a flow chart illustrating the process of an alignment method according to another exemplary embodiment of the present invention.

### DETAILED DESCRIPTION OF THE PREFERRED EMBODIMENT

The present invention may be modified variably and may have various embodiments, particular examples of which will be illustrated in drawings and described in detail.

However, it should be understood that the following exemplifying description of the invention is not intended to restrict the invention to specific forms of the present invention but rather the present invention is meant to cover all modifications, similarities and alternatives which are included in the spirit and scope of the present invention.

While terms such as “first” and “second,” etc., may be used to describe various components, such components must not be understood as being limited to the above terms. The above terms are used only to distinguish one component from another. For example, a first component may be referred to as a second component without departing from the scope of rights of the present invention, and likewise a second component may be referred to as a first component. The term “and/or” encompasses both combinations of the plurality of related items disclosed and any item from among the plurality of related items disclosed.

When a component is mentioned as being “connected” to or “accessing” another component, this may mean that it is directly connected to or accessing the other component, but it is to be understood that another component may exist therebetween. On the other hand, when a component is mentioned as being “directly connected” to or “directly accessing” another component, it is to be understood that there are no other components in-between.

The terms used in the present application are merely used to describe particular embodiments, and are not intended to limit the present invention. An expression used in the singular encompasses the expression of the plural, unless it has a clearly different meaning in the context in which it is used. In the present application, it is to be understood that the terms such as “including” or “having,” etc., are intended to indicate the existence of the features, numbers, operations, actions, components, parts, or combinations thereof disclosed in the specification, and are not intended to preclude the possibility that one or more other features, numbers, operations, actions, components, parts, or combinations thereof may exist or may be added.

Unless otherwise defined, all terms used herein, including technical or scientific terms, have the same meanings as those generally understood by those with ordinary knowledge in the field of art to which the present invention belongs. Such terms as those defined in a generally used dictionary are to be interpreted as having meanings equal to the contextual meanings in the relevant field of art, and are not to be interpreted as having ideal or excessively formal meanings unless clearly defined as having such in the present application.

Embodiments of the present invention will be described below in detail with reference to the accompanying drawings, where those components are rendered using the same reference number that are the same or are in correspondence, regardless of the figure number, and redundant explanations are omitted.

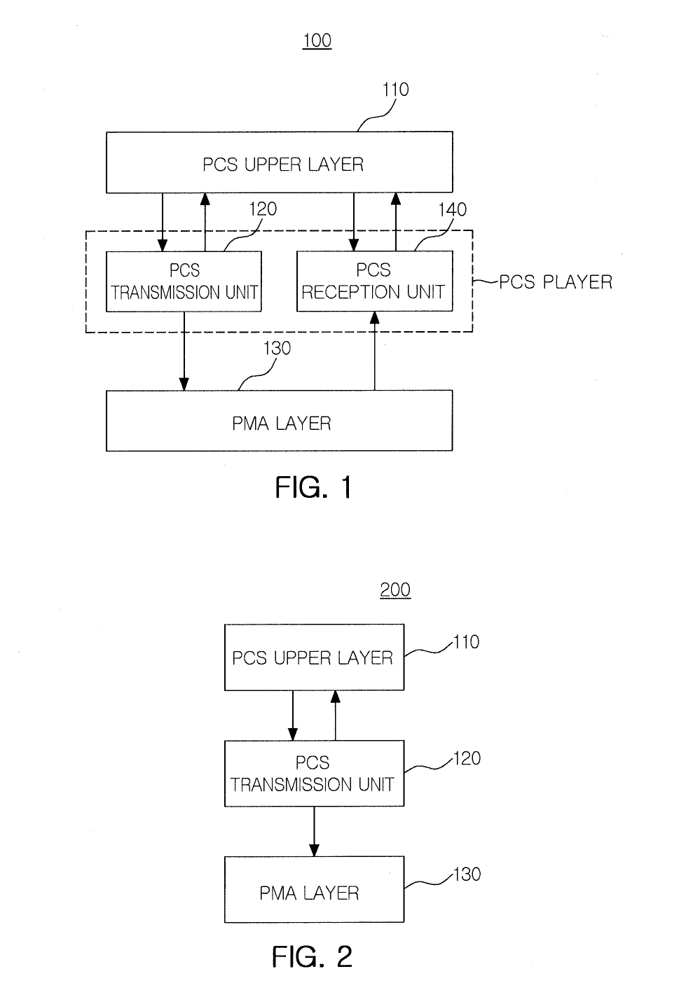

FIG. 1 is a schematic block diagram of an alignment apparatus according to an exemplary embodiment of the present invention.

With reference to FIG. 1, an alignment apparatus 100 according to an exemplary embodiment of the present invention includes a PCS (Physical Coding Sublayer) upper layer 110 managing lane information regarding all of the lanes and lanes in operation (i.e., operational lanes), a PCS transmission unit 120 receiving the lane information from the PCS upper layer and inserting an alignment marker into the operational lanes, a PMA (Physical Medium Attachment) layer 130 receiving the alignment marker from the PCS transmission unit and transmitting the same, and receiving alignment marker from another alignment apparatus, and a PCS reception unit 140 receiving the lane information from the PCS upper layer, receiving the alignment marker from the PMA layer, and performing alignment on the operational lanes.

FIG. 2 is a schematic block diagram of an alignment apparatus according to another exemplary embodiment of the present invention.

With reference to FIG. 2, an alignment apparatus 200 according to another exemplary embodiment of the present invention includes a PCS (Physical Coding Sublayer) upper layer 110 managing lane information regarding all of the lanes and lanes in operation (i.e., operational lanes), a PCS transmission unit 120 receiving the lane information from the PCS upper layer and inserting an alignment marker into the operational lanes, and a PMA (Physical Medium Attachment) layer 130 receiving the alignment marker from the PCS transmission unit and transmitting the same.

The PCS upper layer 110 may manage lane information regarding all of the lanes and the operational lanes that may be used by the alignment apparatus. Namely, the PCS upper layer 110 may manage lane information regarding the overall number of lanes, the number of operational lanes, scheduling between all of the lanes and the operational lanes, and the like.

The lane information in the PCS upper layer 110 may be dynamically changed. For example, the lane information may be changed when new lane information is received from a different apparatus, or the lane information may be changed according to a user setting.

When a high speed Ethernet interface is configured by using a plurality of low speed physical channels, the low speed physical channels may be an example of the lane designated in an exemplary embodiment of the present invention. Besides the physical channels discriminated by physical signals, logical channels in a module that processes electrical packets in a system may be an example of the lane.

The PCS upper layer 110 may provide the lane information to another lane alignment apparatus opposed thereto. For example, in case of changing the lane information according to an operator's setting, lanes may be changed according to operator's configuration information, and the operator's configuration information may be delivered to another apparatus opposed thereto in order to adjust alignment with another apparatus.

The PCS transmission unit 120 may receive the lane information from the PCS upper layer and perform an alignment on the operational lanes.

For example, the PCS transmission unit 120 may receive the lane information from the PCS upper layer 110, configure and change the lanes. The PCS transmission unit 120 may perform various roles for an alignment according to the lane information. Namely, the PCS transmission unit 120 may perform synchronization, scrambling, encoding, lane distribution, and the like, along with alignment.

The PCS transmission unit 120 may insert an alignment marker into each of the operational lanes at every alignment marker insertion period by using the received lane information. Namely, the PCS transmission unit 120 may insert an alignment marker into each of the lanes periodically (at every 16,383 blocks in case of 40G/100G Ethernet) for an alignment with an opposing apparatus.

Also, the PCS transmission unit 120 may use an alignment marker insertion period counter in order to insert the alignment marker. Namely, in order to recognize the alignment marker insertion period, the PCS transmission unit 120 operates a counter, and in the case of 40G/100G Ethernet, when the alignment marker insertion period counter reaches 16,383, the alignment marker may be inserted into each of the lanes.

The PCS transmission unit 120 may change the number of the operational lanes by using the received lane information. For example, when the lane information is dynamically changed in the PCS upper layer, the PCS transmission unit 120 receives the lane information from the PCS upper layer and dynamically changes the number of the operational lanes.

The PMA layer 130 may receive the alignment marker from the PCS transmission unit 120 and transmit the same. Namely, the alignment marker, which has been inserted by the PCS transmission unit 120, may be transmitted to another alignment apparatus opposed thereto via the PMA layer 130.

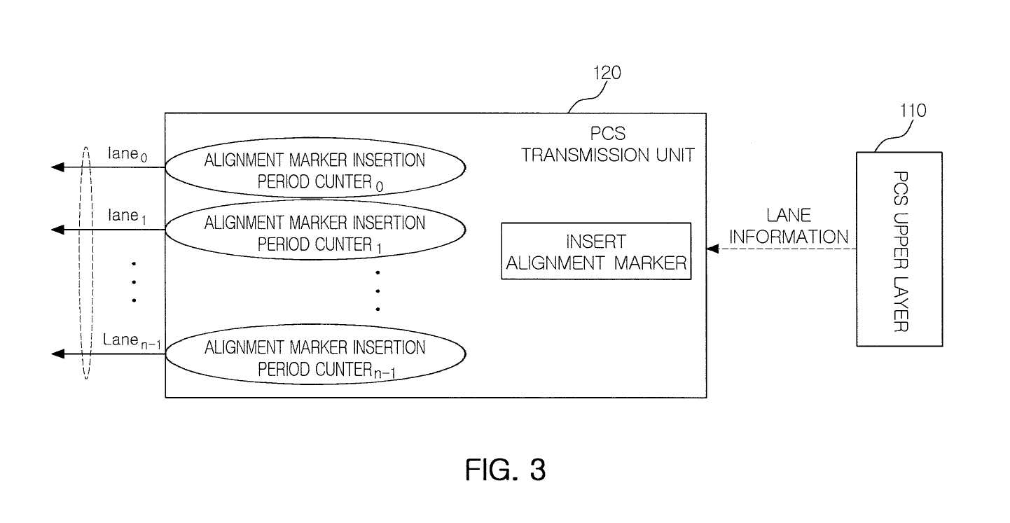

FIG. 3 is a schematic block diagram of a PCS transmission unit of the alignment apparatus according to another exemplary embodiment of the present invention.

With reference to FIG. 3, in the alignment apparatus according to another exemplary embodiment of the present invention, the PCS transmission unit 120 receives the lane information from the PCS upper layer 110 and schedules lanes to be operated in lane 0 to lane n−1 according to the received lane information.

When operational lanes are determined based on the lane information, each of the lanes are operated, and an alignment marker is inserted into each of the lanes in operation with reference to the alignment marker insertion period counter.

The alignment marker may be received by the opposing alignment apparatus and used when an alignment is performed.

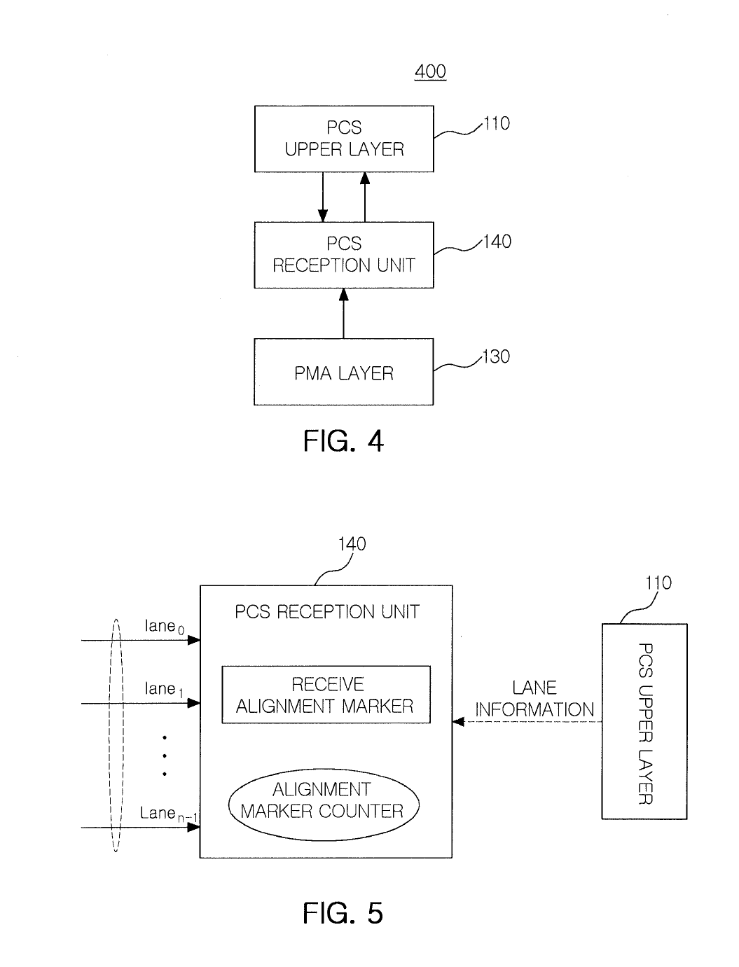

FIG. 4 is a schematic block diagram of an alignment apparatus according to another exemplary embodiment of the present invention.

With reference to FIG. 4, an alignment apparatus 400 according to another exemplary embodiment of the present invention may be configured to include a PCS (Physical Coding Sublayer) upper layer 110 managing lane information regarding all of the lanes and lanes in operation (i.e., operational lanes), a PMA (Physical Medium Attachment) layer 130 receiving alignment marker, and a PCS (Physical Coding Sublayer) reception unit 140 receiving the lane information from the PCS upper layer 110 and the alignment marker from the PMA layer 130, and performing alignment on the operational lanes.

The PCS upper layer 110 may manage lane information regarding all of the lanes and the operational lanes that may be used by the alignment apparatus.

Also, the PCS upper layer 110 may receive the lane information from a different lane alignment apparatus opposed thereto. Namely, the PCS upper layer 110 manages the lane information which has been provided from the opposing different lane alignment apparatus, and when the lane information is changed, the PCS upper layer 110 updates the lane information.

The PMA layer 130 may receive alignment marker from the different alignment apparatus and deliver the received data to the PCS reception unit 140.

The PCS reception unit 140 may receive the lane information from the PCS upper layer and the alignment marker from the PMA layer, and perform an alignment on the operational lanes.

Also, the PCS reception unit 140 may perform the alignment on the operational lanes by using the alignment marker counter.

For example, the PCS reception unit 140 receives an alignment marker by using data received from each of the lanes, and records the received alignment marker in the alignment marker counter. When the recorded alignment marker counter is identical to the number of the operational lanes according to the lane information, the PCS reception unit 140 may perform alignment.

If the recorded alignment marker counter and the number of the operational lanes according to the lane information are not identical, the PCS reception unit 140 may determine it as an error and not perform alignment.

In addition, the PCS reception unit 140 may perform block synchronization, or the like, by lane.

Also, the PCS reception unit 140 may change the number of the operational lanes by using the received lane information. For example, when the lane information of the PCS upper layer is dynamically changed, the PCS reception unit 140 may receive the lane information from the PCS upper layer and dynamically change the number of the operational lanes.

FIG. 5 is a schematic block diagram of the PCS reception unit of the alignment apparatus according to another exemplary embodiment of the present invention.

With reference to FIG. 5, in the alignment apparatus according to another exemplary embodiment of the present invention, the PCS reception unit 140 receives the lane information from the PCS upper layer 110 and schedules lanes to be operated in the lane 0 to lane n−1 according to the received lane information.

When operational lanes are determined based on the lane information, each of the lanes are operated, and it is determined whether or not the number of alignment markers received from each of the lanes is identical to the number of the operational lanes, with reference to the alignment marker counter.

When the number of the alignment marker counter is identical to the number of the operational lanes, alignment is performed, or otherwise, the alignment is error-processed.

In addition, in the case of error-processing after the alignment is performed or without performing the alignment, the alignment marker counter may be reset for a next alignment. Also, in operating the alignment marker counter, a timer may be provided and only an alignment marker received within a predetermined time may be reflected on the counter.

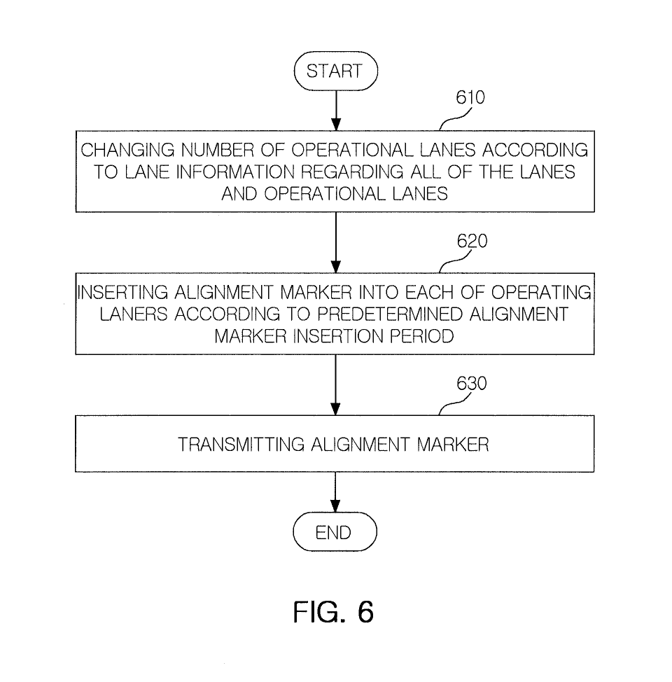

FIG. 6 is a flow chart illustrating the process of an alignment method according to an exemplary embodiment of the present invention.

With reference to FIG. 6, the alignment method according to an exemplary embodiment of the present invention may include a step (610) of changing the number of operational lanes according to lane information regarding all of the lanes and operational lanes, a step (620) of inserting an alignment marker into each of the operational lanes according to a predetermined alignment marker insertion period, and a step (630) of transmitting the alignment marker.

In the step (610) of changing the number of operational lanes according to lane information regarding all of the lanes and operational lanes, the lane information may be dynamically changed.

In the step (620) of inserting an alignment marker into each of the operational lanes according to a predetermined alignment marker insertion period, an alignment marker insertion period counter may be used for the predetermined alignment marker insertion period.

In the step (630) of transmitting the alignment marker, after the alignment marker is inserted, the alignment marker insertion period counter may be reset.

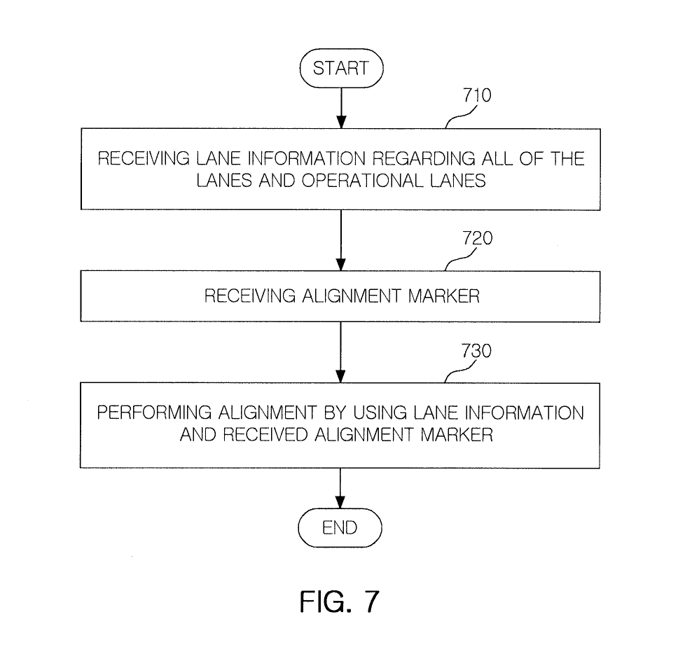

FIG. 7 is a flow chart illustrating the process of an alignment method according to another exemplary embodiment of the present invention.

With reference to FIG. 7, the alignment method according to another exemplary embodiment of the present invention may include a step (710) of receiving lane information regarding all of the lanes and operational lanes, a step (720) of receiving alignment marker; and a step (730) of performing alignment by using the lane information and the received alignment marker.

In the step (730) of performing alignment by using the lane information and the received alignment marker, when the number of the received alignment markers and the number of the operational lanes according to the lane information are identical, the alignment may be completed.

In the step (730) of performing alignment by using the lane information and the received alignment marker, when the number of the received alignment markers and the number of the operational lanes according to the lane information are not identical, the alignment is error-processed and an alignment may be performed by using the alignment marker counter.

As set forth above, according to exemplary embodiments of the invention, an alignment method suitable for a multi-lane-based high speed Ethernet system or device dynamically operating lanes can be effectively provided. Also, a method of inserting an alignment marker by using changing lane information received from a PCS upper layer and a particular mechanism is provided. Furthermore, a method for performing synchronization and alignment according to a dynamically changing environment by using changing lane information, a counter and a timer is provided. Therefore, an environment of a simple, changing network can be effectively coped with.

While the present invention has been shown and described in connection with the exemplary embodiments, it will be apparent to those skilled in the art that modifications and variations can be made without departing from the spirit and scope of the invention as defined by the appended claims.

What is claimed is:

1. An alignment apparatus for dynamically operating lanes in a high speed Ethernet device having multiple lanes, the apparatus comprising:
a PCS (Physical Coding Sublayer) transmission unit receiving lane information regarding all of the lanes and operational lanes from a PCS upper layer and inserting an alignment maker into the operational lanes.

2. The apparatus of claim 1, further comprising:
a PCS upper layer managing the lane information regarding all of the lanes and the operational lanes and providing the lane information to the PCS transmission unit; and
a PMA (Physical Medium Attachment) layer receiving data the alignment marker from the PCS transmission unit and transmitting the same.

3. The apparatus of claim 2, wherein the lane information of the PCS upper layer is dynamically changed.

4. The apparatus of claim 2, wherein the PCS upper layer provides the lane information to another lane alignment device opposed thereto.

5. The apparatus of claim 2, wherein the PCS transmission unit inserts the alignment marker into each of the lanes in operation at every alignment marker insertion period by using the received lane information.

6. The apparatus of claim 5, wherein the PCS transmission unit uses an alignment marker insertion period counter for inserting the alignment marker.

7. The apparatus of claim 2, wherein the PCS transmission unit changes the number of lanes in operation by using the received lane information.

8. An alignment apparatus for dynamically operating lanes in a high speed Ethernet device having multiple lanes, the apparatus comprising:
a PCS (Physical Coding Sublayer) reception unit receiving lane information regarding all of the lanes and operational lanes from a PCS upper layer, receiving alignment marker from a PMA (physical medium attachment) layer, and performing alignment on the operational lanes.

9. The apparatus of claim 8, further comprising:
a PCS upper layer managing the lane information regarding all of the lanes and the operational lanes and providing the land information to the PCS reception unit; and
a PMA layer receiving the alignment marker and providing the same to the PCS reception unit.

10. The apparatus of claim 8, wherein the PCS reception unit performs alignment on the operational lanes by using an alignment marker counter.

11. The apparatus of claim 8, wherein the PCS reception unit changes the number of the operational lanes by using the received lane information.

12. The apparatus of claim 9, wherein the PCS upper layer receives the lane information from another lane alignment apparatus opposed thereto.

13. An alignment apparatus for dynamically operating lanes in a high speed Ethernet device having multiple lanes, the apparatus comprising:
a PCS (Physical Coding Sublayer) upper layer managing lane information regarding all of the lanes and operational lanes;
a PCS transmission unit receiving the lane information from the PCS upper layer and inserting an alignment marker into the operational lanes;
a PMA (Physical Medium Attachment) layer receiving the alignment marker from the PCS transmission unit, and transmitting the same, and receiving alignment marker from another alignment apparatus; and
a PCS reception unit receiving the lane information from the PCS upper layer, receiving the alignment marker from the PMA layer, and performing alignment on the operational lanes.
